(19) United States
(12) Patent Application Publication
(10) Pub. No.: US 2009/0265748 A1
(43) Pub. Date: Oct. 22, 2009

(54) HANDHELD MULTIMEDIA RECEIVING AND SENDING DEVICES

(76) Inventors: Emil Stefanov Dotchevski, Marina del Rey, CA (US); Richard Darrel Wyckoff, Los Angeles, CA (US)

Correspondence Address: Luce, Forward, Hamilton & Scripps LLP, 2050 Main Street, Suite 600, Irvine, CA, 92614, US

(21) Appl. No.: 12/425,297

(22) Filed: Apr. 16, 2009

Related U.S. Application Data
(60) Provisional application No. 61/045,562, filed on Apr. 16, 2008.

(51) Int. Cl. H04N 7/173; H04N 5/44

(52) U.S. Cl. 725/109; 348/734; 348/E05.096

(57) ABSTRACT

A handheld multimedia device connect to the internet to obtain internet content and transmits formatted content, including internet content, to a display, such as a television. Thus, users of the multimedia device have a platform for watching internet television or movies, listening to internet music, and otherwise experiencing internet content without the need to connect a conventional computer to the television. Moreover, in some embodiments, multimedia device allows for seamless interaction with the internet by using the devices as a pointing device—users point the device where they desire a cursor to be on the screen.

### RELATED APPLICATION

This application claims the benefit of and priority to U.S. Provisional Application Ser. No. 61/045,562, filed Apr. 16, 2008, the contents of which are incorporated by reference herein in its entirety.

### BACKGROUND

This application is related to devices and methods for displaying interactive internet multimedia on displays such as televisions.

### SUMMARY

A handheld multimedia device connects to the internet to obtain internet content and transmits formatted content, including internet content, to a display, such as a television. Thus, users of the multimedia device have a platform for watching internet television or movies, listening to internet music, playing games, or otherwise experiencing internet content without the need to connect a conventional computer to the television. Moreover, in some embodiments, multimedia device allows for seamless interaction with the internet by using the devices as a pointing device—users point the device where they desire a cursor to be on the screen.

### DRAWINGS

The above-mentioned features and objects of the present disclosure will become more apparent with reference to the following description taken in conjunction with the accompanying drawings wherein like reference numerals denote like elements and in which:

FIG. 1 is a block diagram of an embodiment of the devices of the present disclosure;

FIGS. 2A and 2B are illustrations of an embodiment of the devices of the present disclosure receiving internet content and sending the same to a display;

FIGS. 3A and 3B are a perspective view and a side view respectively of the devices of the present disclosure;

FIG. 4 is an illustration of an embodiment of the devices and methods of the present disclosure overlaying internet content over television;

FIG. 5 is a perspective view of an embodiment of a display recognition device of the present disclosure;

FIG. 6 is a block diagram of an embodiment of a method of recognizing a display using a display recognition device;

FIG. 7 is an illustration of an embodiment of an image captured by display recognition device and used to identify a display; and

FIG. 8 is a flow diagram of an embodiment of communicating multimedia content using the devices of the present disclosure;

### DETAILED DESCRIPTION

In the following detailed description of embodiments of the present disclosure, reference is made to the accompanying drawings in which like references indicate similar elements, and in which is shown by way of illustration specific embodiments in which the present disclosure may be practiced. These embodiments are described in sufficient detail to enable those skilled in the art to practice the present disclosure, and it is to be understood that other embodiments may be utilized and that logical, mechanical, electrical, biological, chemical, functional, and other changes may be made without departing from the scope of the present disclosure. The following detailed description is, therefore, not to be taken in a limiting sense, and the scope of the present disclosure is defined only by the appended claims. As used in the present disclosure, the term “or” shall be understood to be defined as a logical disjunction (i.e., inclusive of the term “and”) and shall not indicate an exclusive disjunction unless expressly indicated as such or notated as “xor.”

The present disclosure relates to multimedia devices and methods. Specifically, the inventors of the present disclosure have invented a device, together with associated methods, for making internet content accessible on displays, not just computer displays. Indeed, according to embodiments of the present disclosure, a device receives internet content which is formatted and wirelessly sent to a display in a native display format.

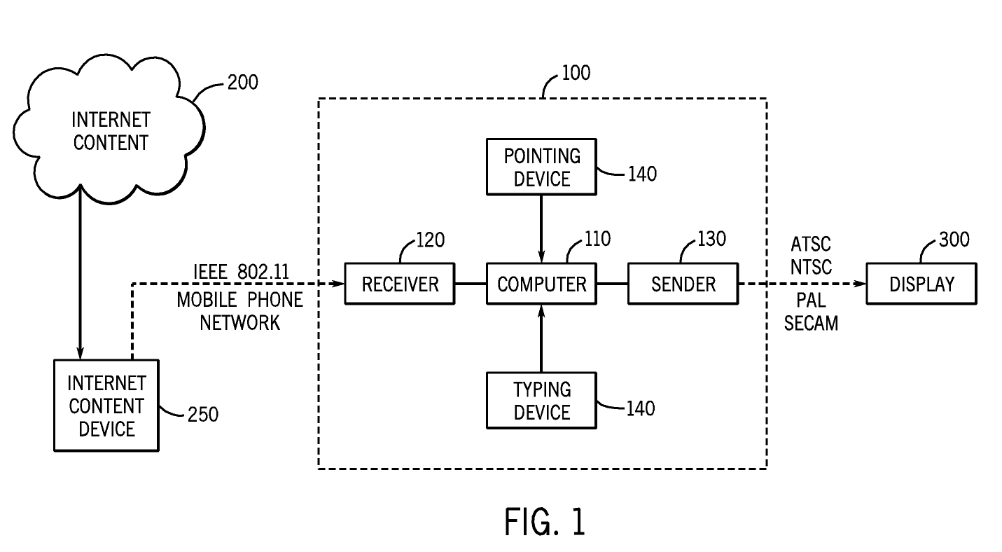

FIG. 1 illustrates the relevant principles. According to embodiments and as shown in FIG. 1, multimedia device is a device that receives internet content 200 via internet content device 250 (e.g., a router, wireless cable modem, etc.), which are well known in the art. According to embodiments, internet content 200 is transmitted to the multimedia device 100 and received via receiver 120, which is configured to receive wireless signals from internet content device 250. Internet content 200 is obtained and formatted to be shown on display 300. Multimedia device 100 then transmits internet content 200 to display 300 wirelessly using sender 130.

Users of multimedia device 100 interact with the internet using one or more input devices 140, which connect to computer 110. Receiver 120 is controlled by computer 110 and receives internet content 200 from internet content device 250, and sender 130 transmits to display 300 internet content 200 that has been formatted for viewing on display 300.

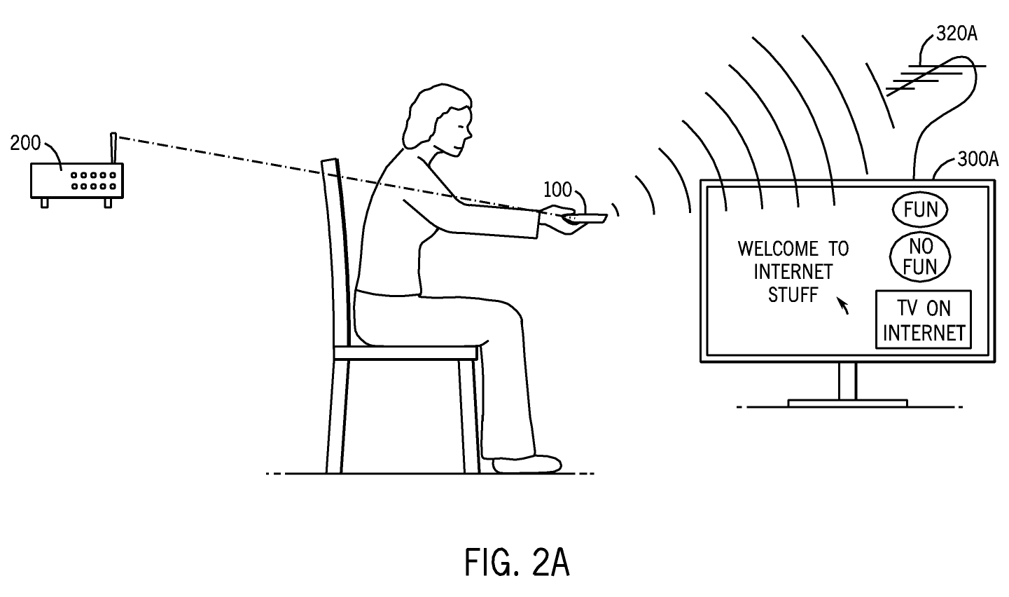

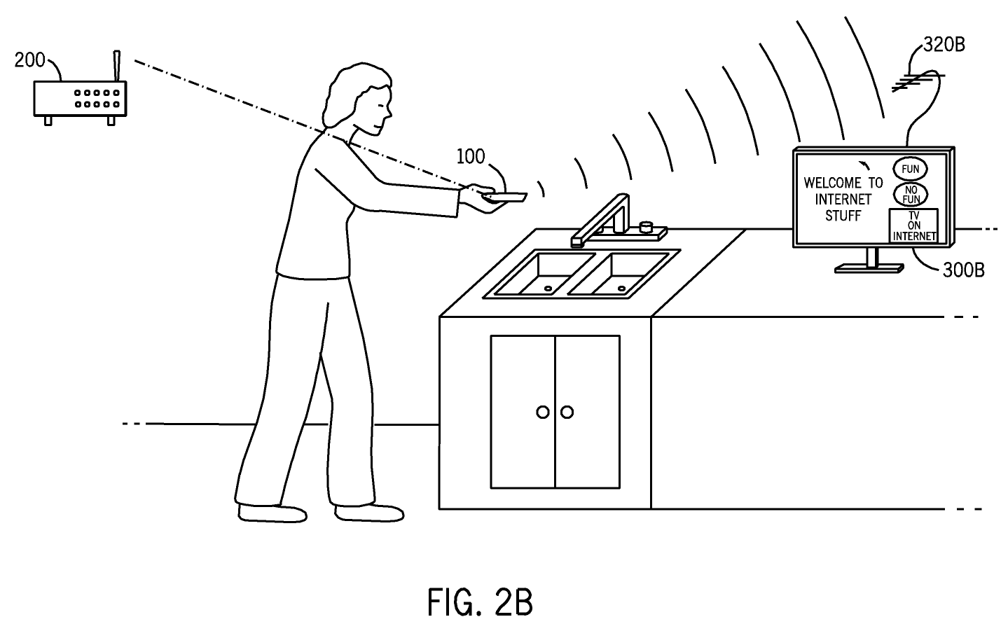

According to embodiments and as illustrated in FIGS. 2 and 3 multimedia device 100 is a handheld device that works with displays 300, such as televisions, provided display 300 can receive a wireless signal from multimedia device 100 and provided multimedia device 100 receives an internet signal. In some embodiments, an internet signal is optional where the content is being provided from multimedia device 100 itself. When a user brings multimedia device 100 within range of display 300, content, including optional internet content 200, is transmitted from multimedia device 100 to display 300.

Shown in FIG. 2 is a representation of multimedia device receiving a wireless signal with internet content 200 from internet content device 250. Multimedia device then formats internet content 200 in a user-friendly graphical user interface (GUI) and outputs the formatted internet content 200 to display 300A via a television standard signal, such as ATSC. Display 300A receives the signal from multimedia device 100 via antenna 320A.

In FIG. 3, the user is no longer in the original viewing location. However, because multimedia device 100 is transmitting internet content 200, the same content that the user was experiencing moments before is transferable to any display 300B (having antenna 320B) configured to receive the wireless signal from multimedia device 100. Thus, multimedia device constitutes a portable solution for experiencing content on any number of displays 300 that can be configured to receive the wireless signal from multimedia device 100.

For example, a user has recorded television content on a digital video recorder (DVR), which is configured as server to stream the recorded content over the internet. The user may use multimedia device 100 to access the recorded content through the internet and watch it on any display 300 in his house using multimedia device 100. Moreover, if the user goes to a friend's house, the user connects multimedia device 100 to his friend's internet connection and can experience the internet content 200 as if he were at his own home on his friend's television. According to another example, the user goes to a hotel and connects into the hotel's internet connection either wirelessly or via a wire and is able to experience internet content 200, including watching the television programs he recorded and made available via his DVR.

For example, a user wants to watch a television show or a movie from a commercial repository of television program content made available via the internet. Such a repository could be a network site where prior episodes of television programs are available for on demand viewing, a third party provider such as Netflix.com or Hulu.com, or even sports offering such as MLB.tv. Such internet content 200 is obtained by multimedia device 100 and formatted and transmitted to display 300 (e.g., a television or computer monitor) for viewing from any location having display 300 that is able to receive the wireless signal and an available internet connection.

According to embodiments, multimedia device 100 is disposed in a housing. Contained within the housing is computer 110, receiver 120, and sender 130. At least one input device 140 is disposed on the exterior of housing to allow users to input commands or other inputs to multimedia device 100. According to embodiments, the housing is configured to be a handheld housing that is comparable to a television remote control or other portable handheld devices, such as cellular phones or digital music players. Generally, the device is intended to be portable and easily carried, held, or moved.

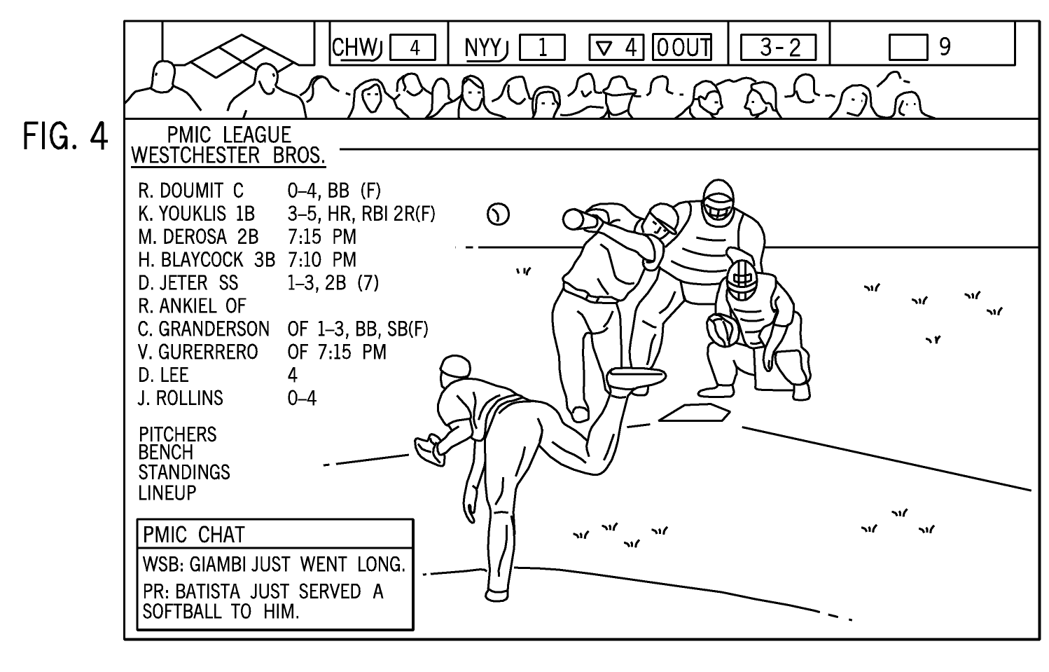

FIGS. 3A and 3B (see also FIG. 5) illustrate an embodiment of multimedia device 100. The device will take on many sizes, configurations, or layouts from that shown in FIGS. 3A and 3B. According to the embodiment illustrated in FIGS. 3A, 3B, there is shown multimedia device 100. As, illustrated, most of the operating components, including computer 110, receiver 120, and sender 130 are disposed inside the housing shown.

The term “computer” as used herein has the meaning commonly associated and known by artisans including, but not limited to, personal computers and personal digital assistants, portable devices having a microprocessor or capable of performing functions traditionally associated with computers, console-type multimedia devices, and set-top devices used to communicate multimedia content to displays. Generally, a computer will have one or more core microprocessors for performing a plurality of tasks (e.g., a central processing unit (CPU), graphics processing unit (GPU), or functional equivalents), or at least one dedicated processing units for performing specific, dedicated instructions.

According to embodiments, the computers of the present disclosure will also comprise a video processing chip or GPU capable of sending video images of a GUI to a display. For example, the NVIDIA Tegra chipset is a suitable processing unit for use with the devices of this disclosure.

According to embodiments, multimedia device 100 comprises a handheld device having a processor and other components common to computers, for example having an ARM or Intel ATOM processor as used in personal digital assistant type devices or mobile phones.

Likewise, memory and data storage for multimedia device 100 may be volatile or non-volatile, according to embodiments. Primary memory may be in the form of random access memory (RAM) or read-only memory (ROM). As artisans will know and understand, memory may also comprise processor registers or processor cached memory. Additionally, forms of non-volatile memory are similarly contemplated, including magnetic memory, such as hard disk drives, solid state disk drives, flash memory, and other forms of storage that would be well known and understood by artisans. According to embodiments, the devices of this disclosure may have both fixed memory that is not removable from multimedia device 100 or removable memory may be used in addition to or in lieu of fixed memory. According to embodiments, separate memory may be used for the GPU.

Multimedia device 100, according to embodiments, is battery powered. Low power embodiments of multimedia device 100 may be powered by alkaline battery sources, for example. Higher power requirements may require specialized power sources, for example nickel metal hydride batteries or lithium ion batteries, which can be tied to a specific recharging station designed for the devices of this disclosure. Artisans will clearly understand the requisite power requirements necessary for each embodiment on a case by case basis and provide a suitable power source without undue experimentation.

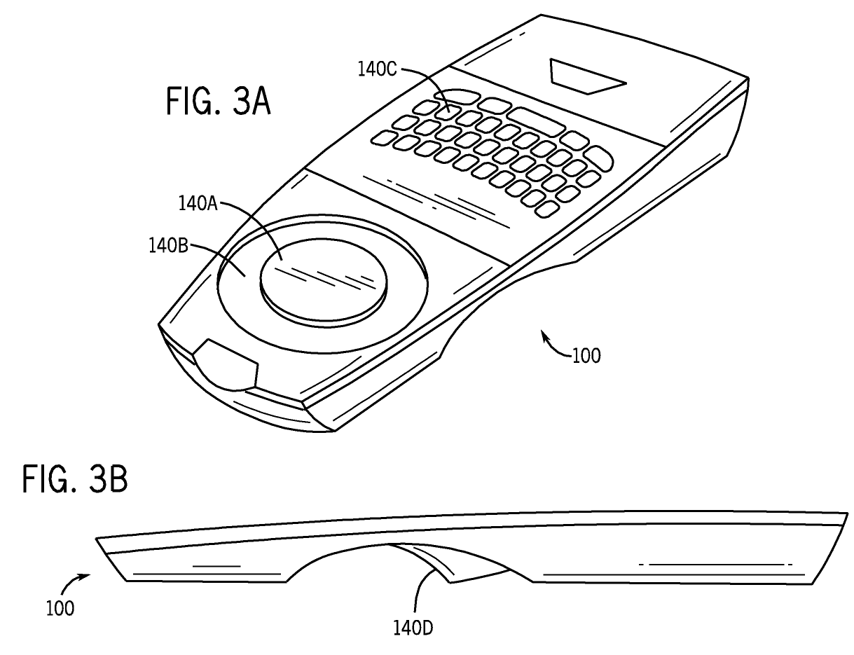

According to embodiments, controllers 140 provide an input mechanism for selecting and interacting with internet content 200. As illustrated in FIGS. 4A and 4B, input devices comprise buttons 140A, 140D, or touch receptive dial 140B, for example. With internet content 200, it is often useful to use keyboard 140C or number pad to type the addresses of uniform resource indictors (URIs) or to interact with internet content 200. These input mechanisms are mapped to at least one command on computer 110, thereby allowing users of multimedia device 100 to interface with and communicate inputs to computer 110, which inputs are correspondingly shown by icons or events on display 300. Artisans will readily appreciate that the configuration of input devices may take on various forms and include many variable components. For example, keyboards, keypads, number pads, additional buttons, touch screens, touch pads, scrolling wheels, accelerometers, vibrating devices, gravity sensing devices, audio-responsive devices, and other input devices installable on remote controls, gaming controls, or computers are appropriate and are expressly contemplated by the present disclosure. Additionally, a microphone may be disposed on device to facilitate social interaction over the internet or for voice controlled commands. Multimedia device 100 may also comprise controllers that are designed specifically for use together with a video game platform.

Receiver 120 comprises, according to embodiments, a transmitter and receiver for wireless communication between computer 110 and internet content device 250. Internet content device 250 is any device configured to provide or route internet content 200 wirelessly (or wired according to some embodiments) to multimedia device 100. For example, internet content device 250 may comprise a wireless router or cell phone tower. Internet content device 250 communicates at least via wireless protocols for transfer of data, which may be proprietary and optimized for the transfer of specific data from internet content device 250 to multimedia device 100, or may be transferred according to well established protocols such as IEEE 802.11, Bluetooth (e.g., IEEE 802.15.x), GSM, CDMA, or 3G, for example. Generally, receiver is designed to work with devices that are configured to send data wireless or wired from point A to point B.

Likewise sender 130 is configured with a transmitter to transmit content from multimedia device 100 to display 300. According to embodiments, sender 130 transmits a signal that is received and used natively by displays. For example, if display 300 is a television, the signal may be ATSC, DVB, ISDB, DTMB, DMB, NTSC, PAL, SECAM, or other standard or nonstandard television broadcast signals. In these cases, the a built-in antenna or another antenna connected to the television would receive the signal and display the content on display 300 similar to receipt and display of other over the air signals. According to embodiments, the signal strength of sender 130 is sufficient for a given area in which display 300 is disposed, but may not be sufficient to transmit to nearby displays 300. For example, sender 130 could be configured to broadcast to some arbitrary range, for example 20 feet; similarly, users may be able to select the signal strength of sender 130 as an option to balance conservation of power versus range of multimedia device 100.

According to embodiments, the signal sent from sender 130 may be scrambled to prevent unauthorized viewing of the content sent from multimedia device 100 to display 300. For example, the ATSC standard has a provision called Conditional Access System for Terrestrial Broadcast, which allows an over-the-air broadcaster to scramble the signal so it cannot be displayed without a required authentication. Conditional Access System for Terrestrial Broadcast provides a suitable platform for content to be transmitted to display 300 through a low-power ATSC signal, while also disallowing unauthorized viewers (e.g., neighbors) to tune their displays 300 to the channel/frequency that sender 130 is transmitting and thereby view the content transmitted from multimedia device 100.

According to embodiments, multimedia device 100 further comprises at least one standard tuner, such as an ATSC tuner, which receives over the air signals. Multimedia device 100 combines and formats content from multimedia device 100, for example internet content 200, and the over the air content and sender 130 transmits a signal to the display 300. According to embodiments, the content from multimedia device 100 is a GUI overlay placed on top of the over the air content. For example, if a user wants to watch an over the air baseball game transmitted on KTLA, the antenna in multimedia device 100 would receive the game. Internet content 200 is also received by multimedia device 100, which is a GUI layer that could be set on top of the game content to show statistics, social networking/interaction, or fantasy baseball statistics, for example.

In another example illustrated in FIG. 4, there is shown an exemplary display of a live baseball sporting event. Multimedia device 100 receives the event in the way it is formatted by the over the air content provider. Multimedia device 100 combines the over the air signal with internet content 200 and overlays the baseball game with internet content 200 from the user's fantasy sports team on the left of display 300. For wider screen displays 300, overlays from multimedia device 100 can be in dark space, if present on the screen, for example where the television content is 4:3, but the screen is 16:9. In the case shown, internet content 200 is overlaid right on top of the baseball game in an inconspicuous spot. According to embodiments, a user would be able to control the placement, size, location, and other configurable presentation options using input devices 140 on multimedia device 100. For example, the user could cause one or more areas of overlayed internet content 200 to be hidden unless a cursor is placed in a certain area of the display 300, or could change the font size, etc. Additionally, because internet content 200 is real time, social networking, such as chatting is permitted as illustrated in FIG. 4, thereby enriching the baseball game viewing experience.

According to embodiments, sender 130 may be coupled to a proprietary signal receiver. The proprietary signal receiver connects directly to display 300 via known methods, e.g., composite, component, HDMI, D-Sub, etc. Moreover, the proprietary signal receiver may be configured to also receive third party content by connecting to cable or satellite receivers or having tuners capable of receiving over the air content. According to embodiments, the proprietary signal receiver would have one or more inputs in which a cable or satellite receiver or the like can be connected. The incoming signal from the cable or satellite box or the like would then be overlaid with content transmitted wirelessly to the proprietary signal receiver from multimedia device 100. Use of a proprietary scrambled signal from sender 130 to proprietary signal receiver is used to ensure privacy, according to embodiments.

Display 300 may be any device capable displaying audio/visual content from multimedia device 100. For example, display may be a television or a computer monitor. Additionally, display 300 could be a billboard, a large stadium display, a arena displays, a projector, and the like, each of which can display multimedia content.

According to embodiments, multimedia device 100 further comprises an operating system for performing the core functions of the device. As will be known and understood by artisans, the operating system controls, from a software level, computer 110, sender 130, receiver 120, and input from input devices 140. Operating system may comprise a commercial operating system, either out of the box or specifically modified for multimedia device 100. For example, Microsoft Windows operating systems, Microsoft Windows Mobile, or unix-based operating systems, such as Linux, are examples of commercially available software that may be used as the operating system of multimedia device 100. According to embodiments, the operating system may also be a proprietary operating system or modified commercial operating system created specifically for multimedia device 100.

Generally, operating system will control the hardware components of multimedia device 100, provide for input, receive content from the internet, and format and transmit data to be displayed on display 300. Operating system may be complimented with additional software such as internet browsers, utilities, multimedia players, games, and the like. The operating system may, according to embodiments, exist stored on a memory device such as a hard disk drive or flash memory that is loaded into volatile memory as needed, or may exist as part of a read-only memory. Artisans will know and understand how to implement and operating system together with the devices of the present disclosure and to perform the methods of the present disclosure.

According to embodiments, the operating system provides web browsing capabilities directly. Moreover, it can include support for third party applications or widgets. Those may be specific to multimedia device 100 or provided by a third party. According to embodiments, the browser of the operating system will identify to internet servers using standard web protocols to allow them to optionally provide special, multimedia-formatted pages, as well as additional data-streams and interactivity compatible with multimedia device 100 user interface. According to embodiments, the operating system provides a signed environment, whereby only signed programs may run within the overlaid operating system's environment.

According to embodiments, multimedia device 100 comprises an application programming interface, complete with development tools, compilers, editors, debuggers and other utility applications to help developers. Support for specialized interfaces, programming environments and languages such as C++, Flash, Java, Silverlight, OpenGL, as well as proprietary video, graphics, gaming and other application programming interfaces is contemplated.

According to embodiments, receiver 120 receives internet content 200 from internet content device 250. Internet content 200 comprises content commonly available on the internet, including web pages, multimedia content in the form of downloadable or streamed music, pictures, and audiovisual content, games, etc. Multimedia device 100, according to embodiments, contains a library of codecs and software for successful display of internet content 200. For example, multimedia device 100 has installed thereon versions of Adobe Macromedia Flash or codecs for playing MP3's, MPEG-4 movies, etc. Commonly used software and codecs not enumerated herein are expressly contemplated; generally, if a home computer can display internet content 200, multimedia device 100 will also be able to display the same internet content 200, often with the installation and use of the necessary codecs or software.

Typically, receiver 120 is configured to receive internet content 200 wirelessly, although configurations may be designed to receive internet content via wire such as Ethernet (e.g., 802.3). According to embodiments, wireless reception may be by conventional standards such as IEEE 802.11, Bluetooth (IEEE 802.15), GSM, CDMA, EDGE, 3G, or other commonly used standards. As will be known and understood by artisans, the wireless internet content may be encrypted by known encryption algorithms, such as WPA, WPA2, WEP, etc. or other encryption standards used in wireless technologies.

According to embodiments, receiver 120 comprises at least an antenna and a device for receiving internet content 200. According to embodiments, receiver 120 is configured to a lower power state to preserve battery life of multimedia device 100.

According to embodiments, sender 130 sends data to display 300 for display of internet content 200 and other desired content, such as menus and software interfaces originating from multimedia device 100. According to embodiments, sender 130 comprises a transmitter that sends a signal to display 300, such as a television, in a format native to display 300. For example, where display 300 is a television, the signal may be a standardized broadcast signal such as ATSC, DVB, ISDB, DTMB, DMB, NTSC, PAL, SECAM, or other standard or nonstandard television broadcast signals, which can be picked up by the tuner in the television via an antenna. Other signals are similarly contemplated including wireless HDMI, Wireless USB, Wifi, or Bluetooth signals, depending on the type of display and the type of signal that can be picked up by display or ancillary receiving devices connected to display hardware. Generally, the signal format must have enough bandwidth and fidelity to transmit digital or analog signals with sufficient clarity to display 300 as to be useful for a user.

Using a standardized broadcast signal such as ATSC allow users to tune a television to the same channel on which multimedia device 100 broadcasts, possibly after attaching a small standard antenna. Moreover, broadcast of a low power ATSC-compatible signal shifted in frequency without altering the actual encoding of the digital data allows analog receivers to shift to the standard ATSC frequencies making it compatible with standard ATSC tuners.

According to embodiments, multimedia device 100 allows users to specify the frequency in which sender 130 transmits formatted content to display 300. Thus, interference on one frequency may be resolved by using another frequency, for example if multiple multimedia devices 100 are used with displays 300 that are in close proximity or if an over the air signal interferes.

Internet content 200 sent by sender 130 is formatted for the specific display 300, such as a television or computer monitor. According to embodiments, internet content occupies substantially all of the viewing area of display 300. Display of internet content 200 is well known in the art; indeed, open source web browsing and display software is readily available and can be incorporated into devices of the present disclosure. Users then are able to use input devices 140 of multimedia device 100 to “surf” the internet, including selecting to view multimedia content such as television shows, movies, and videos via websites such as YouTube.com or Hulu.com; listen to music; play games hosted on the internet or multimedia device 100; or otherwise experience the internet as experienced in front of a computer with a keyboard and a mouse.

According to some embodiments, however, the devices of the present disclosure are intended to be used to enhance viewing of television or video game content not associated with multimedia device 100. In these cases, multimedia device 100 can provide an overlay on display 300 useful for interaction with the content or for social networking for example. In cases where content is being received over the air via antenna in conjunction with a television, useful data or social networking may be overlayed the over the air content. Where a cable box or satellite receiver is present, sender 130 can send a signal to a proprietary signal receiver, which is then used in conjunction with data being sent to display 300 from the cable box or satellite receiver, as disclosed above.

According to embodiments, multimedia device 100 is configured to allow users to specify the dimensions of display 300. Thus, multimedia device 100 will format content to be transmitted to display 300 by sender 130 to have the correct display ratio and resolution. For example, users set the aspect ratio of the display to match that of their display, for example 16:9 and set the resolution to display 1440 horizontal pixels. Other features, for example, color calibration, 3D rendering, and so forth are also contemplated.

Internet content 200 is shown on display 300 with a preformatted GUI, according to embodiments. GUI navigation, according to embodiments, is designed to be point-and-click for ease of use.

As described in detail above, input devices 140 may take on a number of different forms. According to embodiments, input devices may include a pointing device, for example a touch pad, pointing sick, trackball, or directional pad, and a keyboard. According to embodiments, keyboard may be concealed within the housing of multimedia device 100 until desired, at which time the keyboard is slid-out or a removed cover reveals the keyboard. Additionally, where multimedia device is used as a gaming platform, specialized gaming controls comprise input device 140, including specialized control pads, triggers, and strategically placed buttons, for example.

The keyboard, for example, could be a miniature version of a qwerty keyboard as used in common handheld communication devices or smaller keyboards having a plurality of letters associated with each key. Multimedia device 100 may have preprogrammed autocompletion logic to aid users in completing common words after the first few letters are input.

According to embodiments, multimedia device 100 comprises a touch sensitive screen that displays menu options, a keyboard, or allows for manipulation of a cursor. For example, according to embodiments the touch sensitive screen may have the same aspect ration as display 300, and the cursor will be placed on display 300 corresponding to the location on the touch sensitive display where a user places a finger. According to other embodiments, the touch screen need not share the same aspect ratio to be useful in selecting menu options or in placing a cursor. The touch sensitive screen, however, may be limited to dynamic menus that change depending on the content shown on display 300. For example, if a user enters a “Menu” environment on display, a set of menu-specific options will be shown on touch sensitive screen. When a user is watching a movie from an internet provided movie site, the touch sensitive screen may display movie-specific options such as pause, skip, or rewind, and so forth.

According to embodiments, voice recognition software may provide a simple platform for commands to be input into multimedia device 100. Obviously, multimedia device 100 would therefore include a microphone, according to these embodiments. According to other embodiments, multimedia device 100 comprises a microphone as at least one of input devices 140. Microphone may be used for social networking to communicate in real time socially. Voice input would be sent to all other users connected via a social networking protocol and the sound would be broadcast over speakers connected to display 300.

According to embodiments, a pointing device comprises multimedia device 100. That is, the cursor is placed substantially in the location where multimedia device is aimed, much like a laser pointer.

### Display Recognition

According to embodiments, the present disclosure comprises multimedia device 100 having input device 140 which is a display recognition device comprising display recognizer 602 coupled to computer 110. The display recognition device is configured to recognize display 300. By determining where multimedia device 100 is pointed relative to display 300, an icon or cursor is shown on display 300 via the content formatting process. Computer 110 positions an icon on display 300 by transmitting content from sender 130 with a cursor in the position determined, according to embodiments.

According to embodiments and as illustrated in FIG. 5, there is shown an embodiment of multimedia device 100. Multimedia device 100 comprises display recognizer 602 (a specialized input device 140) and other input devices 140. Display recognizer 602 comprises an imaging device, which images the space in which display is positioned and identifies display. According to embodiments, display recognizer 602 may be a video camera, charge-coupled device (CCD), or acoustic imaging device. Generally, display recognizer 602 may be any device that is able to form an image of the environment in which display is located, whereby the position of display 300 is able to be deduced as explained in greater detail below. Artisans will recognize the many variations of display recognizer 602 and other input devices 140 that are possible according to the general principles disclosed herein.

According to embodiments, display recognizer 602 may be a CCD, CMOS digital sensor, or other digital or analog video imaging device useful for capturing video or still images. When multimedia device 100 is aimed at display 300, display recognizer 602 captures images of the space where display 300 is located. From the captured images, display location is determined as disclosed in detail below, for example based on aspect ratios (i.e., the width divided by the height) of common displays. As used herein, the term “captured image” may mean complete images captured much like a photograph or may mean other imaging techniques, for example scanning of lines. After display location is determined, an icon on display is shown with the formatted content transmitted to display 300 by sender 130, whereby the icon corresponds to the location on display 300 where display recognition device 100 is pointed.

Display recognizer 602, according to embodiments, captures images in the visual electromagnetic (EM) range. According to embodiments, display recognizer 602 captures images in the infrared EM range. According to embodiments, display recognizer 602 may capture images in other EM ranges.

According to embodiments, display recognizer 602 may be an acoustic signaler, such as one that images a space based on echolocation-type technologies. According to embodiments, display recognizer 602 may be a light detection and ranging (LIDAR) device, such as one that measures properties of scattered light to find range or other information of a distant target. An output from display recognizer 602 may comprise a point cloud corresponding to the results of the operation of display recognizer 602.

According to embodiments wherein a display recognition device is used, multimedia device 100 is a handheld, remote control-like device. Accordingly, multimedia device 100 may comprise a handheld device that is pointable by a user, whereby it may be variably oriented with respect to display 300.

According to embodiments, an icon, for example an arrow or a crosshair, on display 300 is moved or actuated by moving multimedia device 100. In other words, the icon substantially tracks where multimedia device 100 is pointed relative to display 300. If multimedia device 100 is pointed at the center of display 300, then the icon is centered in the center of display 300; if multimedia device 100 is moved from pointing at the center of display 300 to the upper left of display 300, then the icon is repositioned to track the movement whereby the icon always substantially points to where multimedia device 100 is pointed until multimedia device 100 and the icon are pointing to the upper left of display 300. According to embodiments, movement is polled by computer 110 or communicated from multimedia device 100 to computer 110 on a relatively rapid basis whereby the movement of the icon across the screen appears to be smooth as it tracks the movement of multimedia device 100.

According to embodiments, the orientation, location, and motion of multimedia device 100 relative to display 300 may have a 1:1 correlation with the location of the icon displayed on display 300, as described above. According to embodiments, the relative motion of multimedia device 100 may be multiplied by a coefficient (e.g., a “factor”), such that the relative motion of multimedia device 100 may translate into a suppressed or exaggerated motion of the icon displayed on display 300. According to embodiments, the location of an icon to be shown on display 300 may comprise a direction from a center of display 300 and a distance from the center of the display. The direction to the icon from the center of display 300 corresponds to the direction from the center of the quadrilateral to where multimedia device 100 is pointed. The distance of the icon from the center of display 300 is the distance from the center of the quadrilateral to where multimedia device 100 is pointed, multiplied by a coefficient greater than, less than, or equal to one. According to embodiments, the relationship between the distance of the icon from the center of display 300 and the distance from the center of the quadrilateral to where multimedia device 100 is pointed may be linear, exponential, or be of variable sensitivity. According to embodiments, the factor may be a constant, a variable, or a function of other known or determinable conditions.

For example, according to embodiments, if multimedia device 100 is pointed at the center of display 300, then the icon is centered in the center of display 300; if multimedia device 100 is moved from pointing at the center of display 300 to the upper left of display 300, then the icon is repositioned according to the direction of the movement of multimedia device 100, but in a manner merely proportionate to the movement of multimedia device 100 (e.g., by a factor greater than or less than one). Thus, multimedia device 100 may be pointed at a location beyond the upper left boundary of display 300, and an icon may be displayed in the upper left of display 300 (where the factor is less than one), thereby causing the icon movement on display 300 to be perceived as “slower” and less responsive to minor movements of multimedia device 100. Alternatively, multimedia device 100 may be pointed at a location within the upper left boundary of display 300, and an icon may be displayed at the upper left boundary of display 300 (where the factor is greater than one), thereby causing the icon movement on display 300 to be perceived as “faster” and more responsive to minor movements of multimedia device 100.

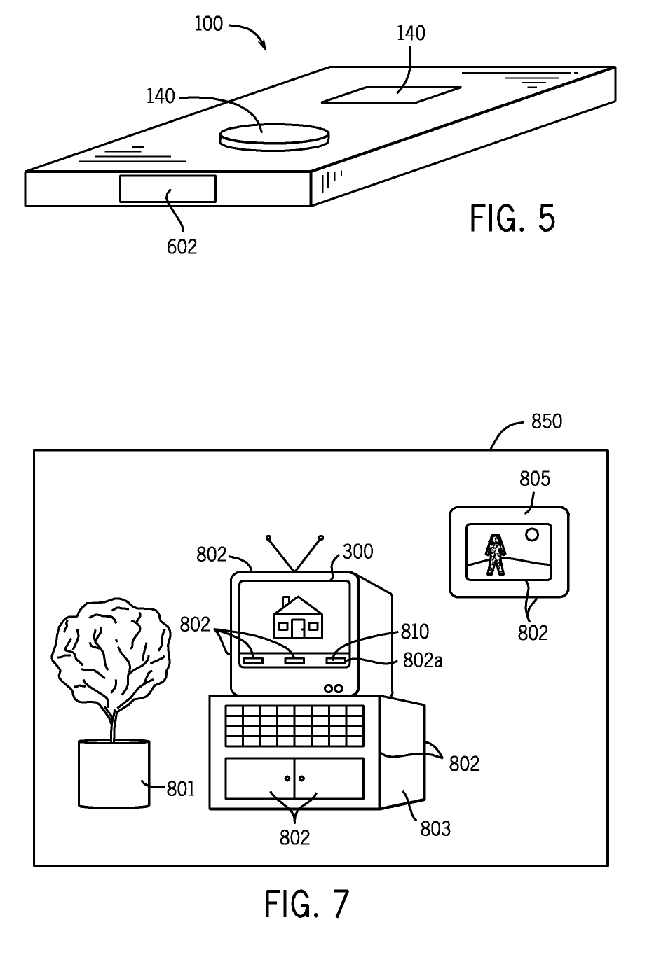

Determination of where the icon is positioned on display 300 is illustrated according to embodiments in FIG. 6. As illustrated, multimedia device 100 captures at least one image of the space in which display 300 resides. Generally, this space may comprise a room or an outdoor venue, for example a stadium having a large display, in operation 702. Images may be captured in a variety of analog or digital formats, for example lossy compression (jpeg), bitmap, tiff compression, and others that would be appropriate for manipulation of the captured image.

According to embodiments, after multimedia device 100 captures an image of the space, the three dimensional images in the image(s) of the space may be mapped from three dimensions to two dimensions in operation 704. This process is performed by the camera lens, as it transforms the three dimensional image into a two dimensional image. Artisans will readily recognize that operations 702 and 704 may be generally accomplished in the same process, that is, during the capture of the image by display recognizer 602.

According to embodiments, multimedia device 100 further comprises an illumination source that illuminates a space in low-light conditions. According to embodiments, the illumination source may provide infrared illumination. Display recognizer 602 may be configured to detect reflected infrared light. Because infrared is outside of the human visible spectrum, an infrared illumination source will not increase the illumination of a dark room as perceived by a human eye, for example.

According to embodiments, once the image has been captured in operation 702 or mapped from 3D to 2D in operation 704, the image may be analyzed in operation 706 to determine edges of the objects in the space, including display 300. Edges are detected, according to embodiments, using both horizontal and vertical scan lines. Scan lines are horizontal or vertical “lines” of an image. Along each scan line, the amplitude of a measurable signal, for example black or white intensity in a black and white image. Thus, the orientation of multimedia device 100 is irrelevant, as all edges of display 300 will be detected. According to embodiments, display recognizer 602 is positioned at 45°, whereby both vertical edges and horizontal edges are detected in the same step.

According to embodiments, the image captured by multimedia device 100 is passed through a Gaussian blur filter. Blurring removes high frequencies with low amplitude, which reduces noise that is naturally present in the input captured image. Other noise-reduction algorithms can be used as well.

For two dimensional images, the Gaussian function may be expressed as:

$$G ( x , y ) = \frac{1}{2 {πσ}^{2}} {e}^{- \frac{{x}^{2} + {y}^{2}}{2 {σ}^{2}}} ,$$

where x is the distance from the origin in the horizontal axis, y is the distance from the origin in the vertical axis, and σ is the standard deviation of the Gaussian distribution. According to embodiments, blurring may be achieved by the optical properties of multimedia device 100.

According to embodiments, the output blurred image may be passed through a Sobel operator to highlight edges. A Sobel operator highlights samples (pixels) with high frequencies (edges), and simultaneously inhibits low frequency pixels. In 2D, the Sobel operator is applied in two passes, one to highlight horizontal edges, and one for vertical.

$${G}_{y} = [ \begin{matrix}+ 1 & + 2 & + 1 \\ 0 & 0 & 0 \\ - 1 & - 2 & - 1\end{matrix} ] * A and {G}_{x} = [ \begin{matrix}+ 1 & 0 & - 1 \\ + 2 & 0 & - 2 \\ + 1 & 0 & - 1\end{matrix} ] * A ,$$

where A is the source image, and Gₓ and G_{y} are two images which at each point contain the horizontal and vertical derivative approximations. The output is a measurement for the horizontal and vertical gradient at each pixel, Gₓ and G_{y}. This output indicates how strong of a horizontal and vertical edge there is at a pixel. The two can be combined to compute an overall gradient G for the pixel:

G=\sqrt{Gₓ²+G_{y}²}

Furthermore, the arctan(G_{y}/Gₓ) gives the angle, Θ, of the edge at the pixel location:

$$Θ = arctan ( \frac{{G}_{y}}{{G}_{x}} ) ,$$

The output from this step, per pixel, indicates the strength of an edge at every given pixel (G) and the angle of that edge (Θ) (from 0 to 360 degrees).

According to embodiments, the output from the Sobel operation, is provided for Canny edge detection. Where the Sobel operator leaves wide edges, a more precise location of each edge may be provided with Canny edge detection. A Canny algorithm finds the pixels where the gradient intensity G from the Sobel operation is a local minimum or a local maximum compared to its neighboring pixels, and discards all other pixels. For example, a pixel having a value of G and having neighbors on the left and right where G is smaller, the pixel in question is identified as a local maximum and that pixel is preserved, identifying a vertical edge. The same is repeated relative to pixels above and below the pixel in question, identifying a horizontal edge, and relative to diagonal pixels, identifying diagonal edges. The output is an edge map, in which each pixel indicates one of the four types of edges it might contain (horizontal, vertical, and the two diagonals) and its strength.

According to embodiments, the separate pixels may be combined to form continuous lines using hysteresis thresholding. A high threshold and a low threshold are established. Pixels are evaluated to determine whether they have a value that exceeds the high threshold. Pixels with such a value are traced in any direction that contains pixels that don't fall below the low threshold. When a pixel is encountered that has a value that falls below the low threshold, the tracing stops.

According to embodiments, the coordinates of the traced pixels are processed using a least squares method or singular value decomposition, to both check if the pixels are on a straight line, and deduce the line equation. Where two lines share a vertex, a connection is assumed. Where four lines are connected by four vertices, then the four lines are assumed to form a quadrilateral. Where multiple line segments align along a common line, the common line may be inferred and applied for purposes of calculating and identifying quadrilaterals. Where lines segments fail to intersect, each line segment may be extended to evaluate whether the lines would intersect if they were extended.

According to embodiments, using the detected edges, quadrilaterals in the space may be identified in operation 708. Because multimedia device 100 will not always be positioned at a right angle to display 300, the quadrilaterals captured in the image may not resemble a rectangle having the aspect ratio of display 300, but rather some form of another quadrilateral. For example, if multimedia device 100 is positioned at an angle of 45°, the closest vertical edge of display 300 will appear to be longer than the farthest vertical edge of display 300 as imaged. Thus, quadrilaterals may be identified rather than rectangles, thereby making irrelevant the angle from which display recognizer 602 is to display 300. Artisans will readily understand that identifiers for qualifying quadrilaterals include apparent aspect ratios, as well as other identifiers.

According to embodiments, after identification of the quadrilaterals in operation 308, one or more operations may be performed in operation set 309 to qualify an identified quadrilateral or one of a set of identified quadrilaterals as display 300. According to embodiments, one or more operations may be performed in operation set 309 to reduce the set of identified quadrilaterals to a set of quadrilaterals potentially qualifying as display 300. According to embodiments, various operations are capable of being performed within operation set 309, in combination or alone, and in any order, wherein each operation has a possibility of qualifying an identified quadrilateral as display 300, eliminating an identified quadrilateral as not being display 300, or ranking an identified quadrilateral based on its probability of being display 300.

According to embodiments, multimedia device 100 may qualify or eliminate a quadrilateral as display 300 based on properties observed in an operation within operation set 709 and comparison of those properties with predetermined identifiers. According to embodiments, properties observed may include: an apparent aspect ratio of a rectangle corresponding to an identified quadrilateral, a hypothetical location of multimedia device 100 based on the apparent aspect ratio of a rectangle corresponding to an identified quadrilateral, the location of an identified quadrilateral within an image captured by multimedia device 100, the amount of visible light emanating from an identified quadrilateral, the amount of infrared radiation emanating from an identified quadrilateral, and the location of an identified quadrilateral relative to other identified quadrilaterals. These properties may be compared with at least one identifier corresponding to analogous features of display 300.

According to embodiments, each identified quadrilateral may be qualified or eliminated based on whether it corresponds to a rectangle having an apparent aspect ratio comparable to the known aspect ratio of display 300. According to embodiments, each identified quadrilateral may be split into a pair of triangles in operation 710. The triangles of each quadrilateral may be analyzed to calculate an apparent aspect ratio as an estimation of the actual aspect ratio of the rectangle to which each quadrilateral corresponds. For example, each of the two triangles may have two sides corresponding to two sides of a given quadrilateral. The ratio of the lengths of the two sides from one triangle may be averaged with the ratio of the lengths of the two sides from the other triangle to determine an apparent aspect ratio of the rectangle to which each quadrilateral corresponds. The apparent aspect ratio may be compared to a desired or predetermined aspect ratio of the desired or predetermined display 300 in operation 712. For example, 4:3 or 16:9 may be a desired or predetermined aspect ratio, although other ratios are also easily adaptable to the principles of the present disclosure. If the apparent aspect ratio of a rectangle corresponding to the given quadrilateral is determined not to fall within a predetermined range of the predetermined aspect ratio of display 300, then the quadrilateral may be ignored in operation 714 and the triangles of the next quadrilateral may be analyzed. If only a single quadrilateral has a requisite ratio, it may be selected and the process may be advanced to operation 722. Otherwise the set of potentially qualifying quadrilaterals may be passed to a resolution process, which may be performed in operation 716 or another operation.

According to embodiments, other aspect ratio-based identifiers may be utilized. For example, a determination of whether a quadrilateral corresponds to a rectangle having the correct ratio may be accomplished by process of elimination. The angle at which a rectangle is viewed affects the appearance of the quadrilateral corresponding to the rectangle when viewed in two-dimensions. Therefore, the process of determining whether a given quadrilateral corresponds to a rectangle having the correct ratio depends on the angle from which the quadrilateral is viewed. In other words, when the image is captured and converted into a 2D image, a transformation occurs for each quadrilateral to map it from a three dimensional shape to two dimensions. The transformation is based on the lens, for example, of the imaging device. For example, a wide angle lens will produce quadrilaterals in an image differently than a fish-eye lens.

Accordingly, to determine whether a given quadrilateral corresponds to a rectangle having a qualifying ratio, an analysis of the 2D image must be de-transformed to determine whether the quadrilateral could actually correspond to a rectangle having a qualifying ratio. Such analysis is based on the known characteristics of the lens, the focal length, and other known data. From these data, a hypothetical location of multimedia device 100 may be determined based on the quadrilateral that is determined to correspond to a rectangle appearing to have a qualifying aspect ratio and the known data in the de-transformation process. Once the hypothetical location of multimedia device 100 is known, it can be deemed plausible or eliminated—for example if it were determined that the rectangle would have to be located 20 feet off the floor or go feet away. Indeed, a set of quadrilaterals may yield multiple hypothetical locations of multimedia device 100 when such an analysis is performed, thereby yielding multiple qualifying quadrilaterals. A selection process would then be performed for each of the quadrilaterals that might qualify to select the quadrilateral that is display 300.

According to embodiments, multimedia device 100 is primarily used with respect to a single space. Consequently, computer 110 may be initialized whereby the relative positions of the quadrilaterals in a space are known. Thus, once the relationship among the quadrilaterals is determined, the location of display 300 is known based on the interrelationship of the quadrilaterals in a given space. As the system detects changes in the quadrilateral relationships, the full method of determining which quadrilateral is display 300 is performed and the resulting relationship is redetermined. For example, a new framed photograph of a fireplace hearth may be placed on the wall in the space in which display resides after the system has been initialized. At least two additional quadrilaterals will be detected—the frame (including matting and the outline of the photograph itself). In another example, a television may be shown on display 300 as part of the multimedia content, which would also be detected as an additional quadrilateral.

According to embodiments, to resolve which quadrilateral among multiple potentially qualifying quadrilaterals has the right ratio, a resolution process may be performed in operation 716 or in another operation within operation set 709. The resolution process comprises methods for determining which quadrilateral is display 300 among multiple quadrilaterals having a requisite ratio. According to embodiments, various resolution techniques may be employed to determine which quadrilateral is display 300.

According to embodiments, resolution may be accomplished in operation 718 by selecting the potentially qualifying quadrilateral that is closest to the center of an image captured by multimedia device 100.

According to embodiments, resolution may be accomplished in operation 720 by selecting one of a plurality of nested quadrilaterals. For example, the outermost one of a plurality of nested quadrilaterals may be selected as display 300. According to embodiments, the largest one of a plurality of nested quadrilaterals may be selected as display 300.

According to embodiments, multimedia device 100 may gather data regarding the amount of visible light a given identified quadrilateral is emanating. Knowing that display 300 is emanating light in the visible spectrum, multimedia device 100 may qualify or eliminate an identified quadrilateral based on the amount or relative amount of light it is emanating.

According to embodiments, multimedia device 100 may gather data regarding the amount of infrared radiation a given identified quadrilateral is emanating. Knowing that display 300 may generate heat, and thereby infrared radiation, multimedia device 100 may qualify or eliminate an identified quadrilateral based on the amount or relative amount of infrared radiation it is emanating.

Comparison of the captured view with the known image may yield information regarding the direction, orientation, and location of the display 300 and features of the known image shown on display 300 relative to the direction, orientation, and location of multimedia device 100 at the time it captured the view of the image. For example, display 300 may show an image with features recognizable by multimedia device 100. The features may be recognizable based on their known characteristics, such as shape, size, color, location relative to other features, etc. The features as captured by multimedia device 100 demonstrate the location of display 300 within the captured view as well as the location of the features relative to the direction in which multimedia device 100 is pointed. The captured view may be compared to the known image independent of the viewpoint of multimedia device 100, based on scale and rotation invariant feature detection. The image shown on display 300 may be fill display 300 or be a partial overlay imposed on at least a portion of display 300. According to embodiments, computer vision algorithms such as SIFT or SURF may be used to recognize the known image as it is shown on display 300 independent of scale or rotation of multimedia device 100 relative to display 300. This analysis facilitates the determination of where an icon corresponding to the direction of multimedia device 100 should be displayed on display 300. Such a method may be performed as a single calibration step or repeatedly during operation of multimedia device 100. Likewise, display recognizer 602 may be used in conjunction with multimedia device 100 or computer 110 to determine generally the direction in which multimedia device 100 moves over time, much like the algorithms that control an optical mouse. These methods can be used alone or in conjunction with those or others disclosed herein.

According to embodiments, if the wrong quadrilateral is selected, multimedia device 100 may have an override button or command sequence whereby the user can tell computer 110 that the wrong quadrilateral was selected. Computer 200 may “remember” the relationship between the quadrilaterals and thereby avoid choosing the quadrilateral that is incorrect in subsequent icon location determination iterations. Thus, for example, if computer 400 selects the screen housing of display 300 rather than the screen itself, the user can instruct computer to select a nested quadrilateral. It should be noted, that if multimedia device 100 is pointed to a position on the qualifying quadrilateral that isn't display 300, it may select the non-display qualifying quadrilateral and output the icon to the corresponding part of display 300.

According to embodiments, after a quadrilateral is selected as display 300, the location of an icon on display 300 may be determined in operation 722. According to embodiments, the location of the icon on display 300 may be determined by positioning the icon at substantially the center of each captured image. More specifically, according to embodiments, the icon may be placed at the pixel position intersected by the imaginary longitudinal parallel line extending through the center of display recognizer 602 of multimedia device 100. According to embodiments, the location of the icon on display 300 may correspond to any selected location on the captured image or may be related to any selected location on the captured image, as discussed further herein.

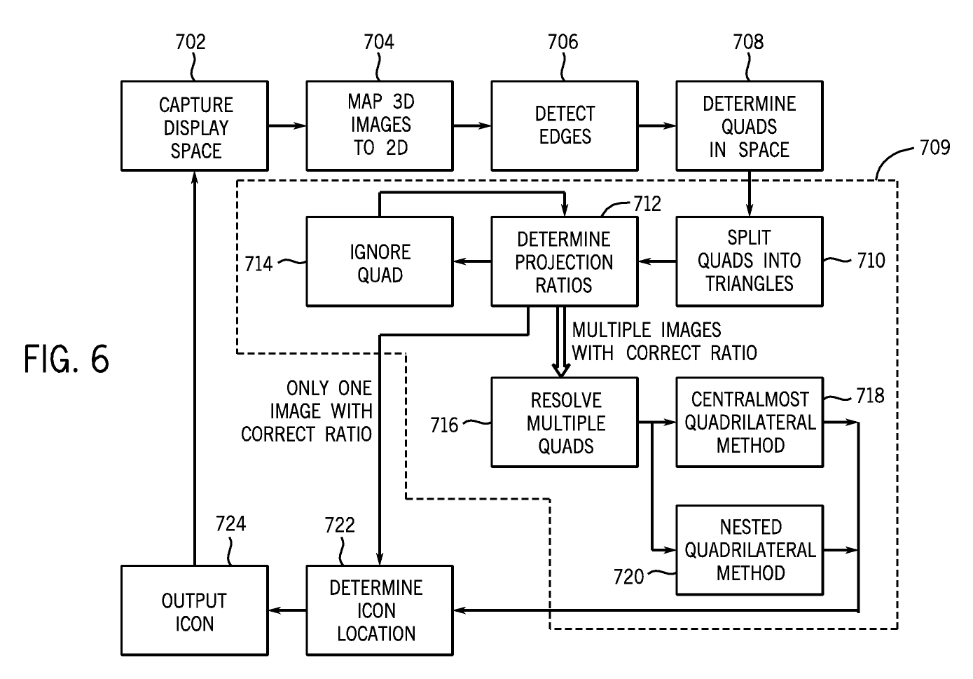

For example, according to embodiments illustrated in FIG. 7, there is shown image 850 captured by display recognizer 602. Image 850 comprises an image of space having potted plant 801, a television having display 300, a television stand 803, and wall hanging 805. Within image 850, there exist a number of quadrilaterals 802, including frame of wall hanging 805, photograph of wall hanging 805, cabinet doors of television stand 803, front and side walls of television stand 803, display 300, and rectangular icons shown on display 300, house door, window, and chimney shown on display 300 as part of the multimedia content. It will be appreciated by artisans that chimney is an irregular quadrilateral, wherein not every angle within the quadrilateral is a right angle. According to embodiments, the methods herein may rule out such quadrilaterals as soon as they are determined to be substantially irregular. Center 810 of image 850 may be represented by a dot.

According to embodiments, image 850 may also be subject to one or more operations (for example, in operation set 709) to qualify or eliminate an identified quadrilateral within image 850 as display 300, as discussed herein. According to embodiments, image 850 may be subject to one or more operations (for example, in operation 722) to determine the location of an icon on display 300.

According to embodiments, each quadrilateral identified in image 850 may be divided into two triangles and the apparent aspect ratio of the rectangle corresponding to each quadrilateral is determined. For example, if the apparent aspect ratio is not 4:3, 16:9, or another predetermined aspect ratio corresponding to the known characteristics of display 300, then the quadrilateral is not determined to be display 300.

Assume that photograph of wall hanging 805 and display 300 are each determined to have an aspect ratio of 4:3. Photograph of wall hanging 805 and display 300 must both go through a resolution step whereby it is determined which is display 300. According to embodiments, the quadrilateral closest to the center 810 of image is selected, which this time corresponds to display 300, wherein center 810 indicates the location toward which multimedia device 100 is pointed.

Assume, however, that display 300 and rectangular icon 802a are determined to be 4:3 and 16:9 respectively. Accordingly, the resolution step would determine that rectangular icon 802a is nested inside of display 300 and therefore select display 300 as the quadrilateral representing display (i.e., choosing the outmost of nested qualifying quadrilaterals).

According to embodiments, the icon may be placed corresponding to the position in the selected quadrilateral closest to center 810. The icon would be positioned corresponding to the same position of center 810. According to embodiments, this position can be represented by an X %, Y % values with respect to display 300 (selected quadrilateral). According to embodiments, position can be represented as a horizontal and vertical pixel coordinates, provided the resolution of display 300 is known. Artisans will known and understand the various other methods of representing the coordinates where icon should be placed.

According to embodiments, the selected location on image 850 corresponds to the location of the icon on display 300. A quadrilateral selected as display 300 appears on image 850. The selected location on image 850 may be within the quadrilateral. The quadrilateral may be divided into two triangles, and the selected location may be determined to be within one of these two triangles. Barycentric or areal coordinates may be determined based on the position of the selected location relative to the vertices of the triangle within which the selected location appears on the image. Because the vertices of the triangle correspond to three known vertices of display 300, the coordinates may be mapped onto display 300 to determine the appropriate location for the icon to be shown on display 300.

After the coordinates of where multimedia device 100 is pointed are known, icon is output to display 300 in operation 724, corresponding with the position where multimedia device 100 is pointed. According to embodiments, the above-described process may be repeated over a rapid interval, for example 10 times per second, whereby the icon will appear to be responsive to even small movements of multimedia device 100 with respect to where multimedia device 100 is aimed.

According to embodiments, an apparent aspect ratio of a rectangle corresponding to a quadrilateral identified in image 850 may be determined based on the four vertices of each quadrilateral. The actual position (including location and orientation) of multimedia device 100 with respect to each identified quadrilateral and the actual aspect ratio corresponding to each identified quadrilateral may be unknown. A hypothetical position of multimedia device 100 relative to each identified quadrilateral may be calculated, and each hypothetical position may be evaluated for its likelihood to be the actual position of multimedia device 100.

According to embodiments, knowing a predetermined aspect ratio corresponding to the known characteristics of display 300 (4:3, 16:9, etc.), and knowing the optical characteristics of display recognizer 602, a hypothetical position corresponding to each identified quadrilateral may be calculated. The hypothetical position for a given quadrilateral is the position that multimedia device 100 would need to assume for the given quadrilateral to correspond to a rectangle having an actual aspect ratio equal to that of display 300. The actual aspect ratio is calculable based on the apparent aspect ratio, the optical characteristics of display recognizer 602, and the assumed hypothetical position of multimedia device 100. Thus, an assumption for the purpose of calculation may be made for each identified quadrilateral that it is or may be display 300.

For example, if the apparent aspect ratio of a first rectangle having a corresponding first quadrilateral based on image 850 is 4:3, and display 300 is known to be 4:3, then the first hypothetical position of multimedia device 100 (relative to the first quadrilateral) at the time image 850 was captured would be a position orthogonal to the first quadrilateral. The first hypothetical position may not be the actual position of multimedia device 100 relative to the first quadrilateral. If the apparent aspect ratio of a second rectangle having a corresponding second quadrilateral based on image 850 is 5:3, and display 300 is known to be 4:3, then the second hypothetical position of multimedia device 100 (relative to the second quadrilateral) at the time image 850 was captured would be a position that would transform an actual aspect ratio of 4:3 into an apparent aspect ratio of 5:3 (such as a position not orthogonal to the second quadrilateral). The second hypothetical position may not be the actual position of multimedia device 100 relative to the second quadrilateral.

According to embodiments, multimedia device 100 may compare each hypothetical position and determine which is most likely the actual position of multimedia device 100. For example, where the first hypothetical position is orthogonal to the first quadrilateral, and the second hypothetical position is not orthogonal to the second quadrilateral, multimedia device 100 may conclude that the first hypothetical position is preferred, based on an assumption that a user is more likely to position multimedia device 100 orthogonal to display 300. Therefore, multimedia device 100 may assume that the first quadrilateral is display 300, and select it accordingly. Any assumption regarding preferred positions of multimedia device 100 relative to display 300 may be pre-selected, user-defined, or based on usage data relating to the historical position of multimedia device 100. These principles are also applicable for determination of the location of multimedia device 100 in three-dimensional space. This information may be used as a source of input, for example in a gaming context to position a flashlight beam based on the direction multimedia device 100 is pointed and the origin of multimedia device 100 relative to display 300.

According to embodiments, the operations of FIG. 6 are performed on computer 110. For example, display recognizer 602 may solely capture an image display space in operation 702 and transfer each image as a low bandwidth lossy compressed file for processing on computer 110 for completion of the other steps. According to embodiments, display recognizer 602 may perform capture of the display space in operation 302 followed by mapping of the three dimensional image to a 2D image. The 2D image is then transmitted to computer 110 for further processing.

According to embodiments and due to the power requirements of computer 110, receiver 120, and sender 130, power consumption may be an issue with multimedia device 100. Multimedia device 100 is therefore powered using lithium ion batteries, according to embodiments. Nickel metal hydride or nickel-cadmium batteries may also be used in some embodiments. According to embodiments, alkaline batteries are used. According to embodiments, custom built battery packs power multimedia device 100. According to other embodiments, batteries conform to commercial batter size and power standards.

According to some embodiments where a rechargeable battery is used, multimedia device 100 is coupled to a recharging station, which is connected to an electricity source and charges the battery of multimedia device 100. Likewise, multimedia device 100 may have an auxiliary port for direct connection to an electricity source to both operate multimedia device and charge the battery.

According to embodiments, multimedia device 100 is coupled with conventional remote control features, such as controllers for television, VCRs, DVD players, cable boxes, satellite receivers, audio devices, etc. Thus, a user would not need to use separate devices for changing the volume of a television while using multimedia device 100. Naturally, multimedia device 100 would comprise the appropriate signaling hardware as well known and understood in the art, for example an infrared or RF transmitter and the appropriate buttons or command mapping to buttons present on multimedia device 100.

According to embodiments, multimedia device 100 provides a built-in or web-hosted “home page” that acts as portal to the internet formatted for the primary display with which multimedia device 100 is used. According to embodiments, such a portal is configured for viewing on a big screen at a distance including: less text, more visuals, categorized by type (news, entertainment, music, games, etc.), topics (politics, science, comedy), or genre.

According to embodiments, multimedia device 100 serves as a platform for various social networking activities. For example, multimedia device 100 provides an on-screen IM buddy list, possibly using proprietary platforms such as Yahoo, MSN, ICQ, Google, Skype, MySpace, Facebook, Twitter, etc. According to embodiments, it allows experiencing of content synchronously with your friends. For example, if one user pauses an online television show or video game, the show or video game also pauses for the other users experiencing the content synchronously with the first user.

Moreover, the content might have one or more social-networking data streams, according to embodiments. For example, multimedia device 100 allows for real time commentary by the users experiencing the content via microphone, listing of other similar content available, advertising and other “sponsored links”-type of information, or interactive features that connect the viewer to other people who watched or liked the show or game, for example real-time voting, etc.

According to embodiments, multimedia device 100 provides real-time or off-line feedback for users' viewing patterns and general navigational experience. For example, multimedia device 100 will report how many times a user has clicked on a particular icon or video, what sites the user has visited, how many instant messages or chats they've sent, how long they have used multimedia device 100, as well as information about the version and status of their device, such as battery life, storage capacity, etc. These statistics may be collected for purposes of user direct advertising or other purposes. According to embodiments, user privacy is maintained and no such data is collected if the user opts out of having the data collected.

According to embodiments, user accounts store user-specific information such as preferences, customized menus based on each user's unique interests, lists of favorite links, videos, or games, etc. Each multimedia device 100 allows multiple user accounts or profiles to be created and selected, according to embodiments. User accounts could optionally be server driven based on logging in via an internet portal.

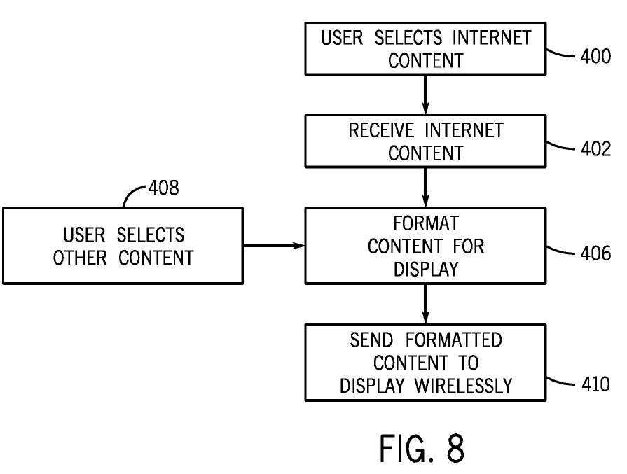

FIG. 8 illustrates embodiments of the methods of the present disclosure. According to the method, a user uses multimedia device 100 to display content on display 300. Accordingly, the user selects one of internet content to show in operation 400 or other content in operation 408. According to embodiments, other content is content stored in the memory of multimedia device 100 or on a computer on a local area network or digital video recorder, such as a menus, navigation features, games, music, movies or videos, presentations, documents, etc. When internet content 200 is selected by the user in operation 400, receiver 120 receives internet content 200 from internet content device 250 in operation 402.

Multimedia device 100 formats internet content 200 or other content for display on display 300 in operation 406. Formatting may be rendering the content in the correct aspect ratio to be displayed on display 300 or formatting the content in windows that occupy substantially less than the entire area of display 300. Multimedia device 100 also formats also other content for display as well. Formatting may include making certain content elements opaque if content is going to be overlaid on other content, for example. Once formatted, sender 130 sends the formatted content to display 130 in operation 410, where it is shown on display 300.

In various embodiments, the devices and systems of the present disclosure are operational in a multimedia-type setting with numerous other general purpose or special purpose computing system environments or configurations or other complex systems. Examples of well known computing systems, environments, or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The devices, systems, and methods disclosed herein may be described in the general context of computer-executable instructions, such as program modules, being executed by a computer. Generally, program modules include routines, programs, objects, components, data structures, etc. that perform particular tasks or implement particular abstract data types. The system may also be practiced in distributed computing environments where tasks are performed by remote processing devices that are linked through a communications network. In a distributed computing environment, program modules may be located in both local and remote computer storage media including memory storage devices. The computer programs are stored in a memory medium or storage medium or they may be provided to a processing unit through a network or I/O bus.

In one aspect, multimedia device 100 includes at least one central processing unit (CPU), graphics processing unit (GPU), or processor. The CPU/GPU can be coupled to a memory, ROM, or computer readable media containing the computer-executable instructions for at least receiving internet content 200 from internet content device 250, sending formatted content to display 300, or executing computer-executable instructions in both temporary and long-term memory. Computer readable media can be any available media that can be accessed by the system and includes both volatile and nonvolatile media, removable and non-removable media implemented in any method or technology for storage of information such as computer readable instructions, data structures, program modules or other data. Computer storage media includes, but is not limited to, RAM, ROM, EEPROM, flash memory, portable memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by multimedia device 100 and at least the methods disclosed herein.

Communication media typically embodies computer readable instructions, data structures, program modules, or other data in a modulated data signal such as a carrier wave or other transport mechanism and includes any information delivery media. By way of example, and not limitation, communication media includes wired media such as a wired network or direct-wired connection, and wireless media such as acoustic, RF, infrared, or other wireless media. Combinations of any of the above should also be included within the scope of computer readable media. The computer readable media may store instructions or data which implement all or part of the system described herein.

While the apparatus and method have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A device comprising:
a handheld housing having at least one input device;
a receiver configured to wirelessly receive internet content;
a sender configured to send a wireless signal to a display to display the internet content.

2. The device of claim 1, wherein the display is a television.

3. The device of claim 2, wherein the wireless signal is selected from the group consisting of ATSC, DVB, ISDB, DTMB, DMB, NTSC, PAL, SECAM broadcast standards.

4. The device of claim 1, wherein the wireless receipt of internet content is via IEEE 802.11 standard.

5. The device of claim 1, wherein the wireless receipt of internet content is via a mobile phone network data transfer standard.

6. The device of claim 1, wherein the sender also configures non-internet content for display on the display.

7. A device comprising:
a handheld housing having at least one input device;
a receiver configured to wirelessly receive internet content;
a sender configured to send a wireless signal to a display;
a display recognizer for placing a cursor on the display substantially corresponding to the projected line from a predetermined point on the device to the display;

8. The device of claim 7, wherein the display is a television.

9. The device of claim 8, wherein the wireless signal is selected from the group consisting of ATSC, DVB, ISDB, DTMB, DMB, NTSC, PAL, SECAM broadcast standards.

10. The device of claim 7, wherein the wireless receipt of internet content is via IEEE 802.11 standard.

11. The device of claim 7, wherein the wireless receipt of internet content is via a mobile phone network data transfer standard.

12. The device of claim 7, wherein the sender also configures non-internet content for display on the display.

13. A method comprising:
receiving internet content to a handheld device;
preparing the internet content to be displayed on a display;
wirelessly sending the internet content from the handheld device to the display; and
interacting with the internet content displayed on the display via the handheld device;
wherein interaction with the internet content displayed on the display is effected by the handheld device recognizing the display and placing a cursor on the display in substantially the same location where the handheld device is pointed.

14. The method of claim 13, wherein the sending of the internet content to the display uses at least one of the broadcast standards selected from the group consisting of: ATSC, DVB, ISDB, DTMB, DMB, NTSC, PAL, SECAM.

15. The method of claim 13, wherein the receipt of internet content is via IEEE 802.11 standard.

16. The device of claim 13, wherein the wireless receipt of internet content is via a mobile phone network data transfer standard.

17. The method of claim 13, wherein the sender also configures non-internet content for display on the display.
